(19) United States
(12) Patent Application Publication
(10) Pub. No.: US 2019/0293845 A1
(43) Pub. Date: Sep. 26, 2019

(54) MIRROR FOR A HUMID ENVIRONMENT

(71) Applicant: SAINT-GOBAIN GLASS FRANCE, Courbevoie (FR)

(72) Inventors: Xiaolin PARDAL, THOUROTTE (FR); Vincent RACHET, SAINT-CYR EN VAL (FR)

(21) Appl. No.: 16/301,675

(22) PCT Filed: May 11, 2017
(86) PCT No.: PCT/FR2017/051135

§ 371 Date: Nov. 14, 2018

(30) Foreign Application Priority Data
May 25, 2016 (FR) 1654679

(51) Int. Cl. G02B 5/08; A47G 1/02; C03C 17/36

(52) U.S. Cl. CPC G02B 5/0858; A47G 1/02; C03C 17/3605; C03C 17/3649; C03C 2217/72; C03C 17/3684; C03C 2217/45; C03C 2217/485; C03C 17/3663

(57) ABSTRACT

A mirror to be tempered includes a glass substrate, a stack of thin layers deposited on one face of the substrate, the stack including a chromium-based or niobium-based metal layer, a coating layer above the stack of thin layers with reference to the glass substrate, in which the coating layer is a layer of mineral paint includes a mixture of an alkaline silicate and at least one white, colored or black pigment.

The present invention relates to a mirror to be tempered and/or a tempered mirror, intended to be used in any environment and especially a humid environment such as a bathroom or in a kitchen, especially for decorating a backsplash panel.

Mirrors currently are generally obtained by means of depositing a fine metal layer, in principle silver, onto a glass substrate.

At the present time, mirrors are manufactured in various ways, depending on the use that will be made thereof. Mirrors that are commonly used in domestic households were until recently manufactured from a more or less thick glass plate onto which is applied a layer that reflects visible radiation, based on silver or, less commonly, aluminum, followed by a protective layer of copper or lead, known as the silvering. The glass serves as support and also as protection for the reflective layer, whereas the silvering prevents oxidation of the reflective layer.

Conventionally, a mirror is manufactured from a single glass pane (referred to as glazing in the present description) onto which is sprayed a solution of silver salt. A second product, which reacts with the salt, is then sprayed onto the mirror so as to leave thereon only a thin layer of silver metal. After drying the reflective layer, the protective layer is applied.

At the present time, the process for depositing the silvering is a multi-step process comprising successive treatments of the surface of the glass support with agents such as SnCl₂, PdCl₂ and AgNO₃, followed by covering the silvering with a coating layer.

In a known manner, for safety reasons, the glass support (or substrate) must be tempered. The reason for this is that, after thermal tempering, the mechanical strength of the glass is considerably increased. Tempered glass also has the advantage of fragmenting into a multitude of small splinters that do not cut in the event of breakage.

Mirrors based on silver or aluminum are, however, very sensitive to oxidation especially in humid environments such as a bathroom or kitchen.

Other stacks comprising metal layers other than aluminum or silver have been developed, which have a high degree of light reflection, especially greater than or equal to 50%, and better resistance to oxidation, especially by water.

Such novel silvering-free reflective glasses with high light reflection are, according to a first example, designed using a reflective layer of chromium as described in patent application EP962429 A1. Said publication especially indicates that such a thin layer deposited onto the glass substrate is capable of undergoing all the transformations of standard glazing, in particular a heat treatment, without substantial modifications of its optical and/or colorimetric properties. Mirror glazings equipped with such a stack of layers can thus be tempered especially to satisfy the requirements for safety glasses.

According to another approach, other stacks also having very good resistance to oxidation, especially in a humid environment, are also known, for example from patent application EP 1218 307 B1, this time on the basis of a niobium-based layer which reflects infrared.

The Applicant Company realized that, as with stacks comprising a chromium-based layer, glazings of mirror type, i.e. with very high light reflection and virtually zero light transmission, may also be obtained by depositing these niobium-based layers onto a glass substrate. As described in patent application EP 1218307 B, such glazings equipped with such stacks of layers are also capable of undergoing heat treatments of tempering type without significant variations in their optical and/or colorimetric properties.

A first drawback concerning the use of such chromium-based or niobium-based layers in glazings used as mirrors is, however, their low residual light transmission.

Thus, whether for chromium-based stacks or niobium-based stacks and even for relatively high thicknesses of the reflective metal layers, light transmission is observed, which, although small (about 1%), may harm the rendering of the mirror by not offering the opacity desired for a mirror plate glass, for example of the type used in a kitchen backsplash panel. In such a case, even if the light transmission is small, it still remains possible to detect through the glazing the adhesive used to fix the mirror onto the backsplash panel.

To obtain a totally opaque mirror, it is thus necessary to provide an additional layer on the stacks comprising the niobium-based or chromium-based reflective layers.

Publication EP 962429 A1 indicates, for example, the possibility of depositing an additional layer made of opaque enamel onto the stack comprising the reflective layer to manufacture spandrels.

Such a production, although technically achievable, nevertheless poses the problem of the strength of the enamel, which, before melting, has very low mechanical and hydrolytic strength. It is therefore not possible to transport, store, cut, trim or wash a glass coated with such an enamel until such time that it has been heated to high temperature, typically above 600° C., i.e. until such time that the deposited layer has melted.

However, unless an additional distempering step is performed, a tempered glass can no longer be transformed. Consequently, the enamel must imperatively be deposited onto panels having their final dimensions, without the possibility of cutting, before it is transported to the retailer or to the consumer. In such a process, it thus proves necessary to temper it at the site of production, which is not always easy, or even possible. The production of such a product is thus poorly suited to the interior habitat where the dimensions of the glazing are personal to the client, especially in the case of a backsplash panel whose dimensions may be personal to each installation.

For essentially economic reasons, it thus proves necessary to be able to propose a transportable product, consisting of an opaque mirror which is practically finished but which can be cut and transformed directly (including tempered) by the retailing client, without the need for an expensive implementation means.

The object of the present patent application is to solve such a problem.

In particular, the Applicant Company has discovered a product that solves the preceding problems at little cost. The product according to the invention especially comprises a chromium-based or niobium-based reflective layer, which can be transported without difficulty, or alternatively stored in order subsequently to be formed, in particular cut to the required dimensions, and then finally tempered in the subsequent step of marketing to the final client. Such a product particularly finds its application in a use in a humid environment, in particular as a mirror in a bathroom or kitchen. Such a mirror may especially be used as a backsplash panel facade.

More particularly, the present invention relates firstly to a mirror to be tempered or a temperable mirror, comprising:
a glass substrate,
a stack of thin layers deposited on one face of said substrate, said stack comprising a chromium-based or niobium-based metal layer, one or more underlayers made of dielectric materials, and one or more overlayers made of dielectric materials, said underlayers and overlayers being arranged, respectively, below and above the metal layer, with reference to the glass substrate,
a coating layer above said stack of thin layers with reference to the glass substrate.

According to the invention, said coating layer is a layer of mineral paint comprising a mixture of an alkaline silicate and at least one pigment. This pigment may be white or colored or alternatively, preferably, black. Preferably, said pigment is chosen (and its concentration adjusted) so that the coating layer in which it is included, before tempering and preferably after tempering, is of dark color and more preferably is substantially black.

The term “dark color” means an L* value of less than or equal to 50, preferably less than or equal to 45 or even less than or equal to 40, in the international L*a*b* system.

The term “substantially black” means an L* value of less than or equal to 30 in the international L*a*b* system, preferably less than or equal to 25 or even less than or equal to 20.

The coating layer according to the invention preferably has in particular an L* value of between 5 and 50, limits inclusive.

Advantageous and preferential characteristics of the mirror according to the present invention, which are, however, not limiting and may where appropriate be combined together, are given below:
the coating layer has an L* value of less than or equal to 50, in the CIE L*a*b* system.
the coating layer has an L* value of less than or equal to 30, in the CIE L*a*b* system.
the thickness of the chromium-based or niobium-based layer is between 10 and 100 nm, preferably between 20 and 80 nm and is preferably between 30 and 70 nm.
the metal layer is based on chromium.
the metal layer is based on niobium.
the coating layer comprises between 5% and 15% by mass of sodium silicate, potassium silicate and/or lithium silicate.
the coating layer comprises between 5% and 50% by mass of pigment, preferably between 10% and 30% by mass of pigment.
the coating layer comprises at least one pigment chosen from oxides or sulfides comprising at least one element chosen from iron, manganese, copper, aluminum, chromium, antimony or cobalt; titanium, silicon, copper, aluminum, chromium, cobalt, iron or manganese oxides or sulfides; zinc, cerium and/or cadmium sulfide; nickel and/or chromium titanates; or bismuth vanadate.
the coating layer comprises at least one pigment based on iron oxide, iron manganese oxide, iron titanium oxide, manganese oxide, chromium oxide, cobalt oxide, tin antimony oxide.
the coating layer also comprises a dispersant, an antifoam agent, a thickener, a stabilizer and/or a hardener, said agents especially being present in an amount of between 0.01 and 5% by mass of the paint, preferably between 0.01 and 1% by mass.
the coating layer comprises pigment particles less than 5 micrometers in size, preferably less than 2 micrometers in size.
the coating layer has a thickness of at least 10 micrometers, preferably of at least 20 micrometers, more preferably of at least 50 micrometers.

The invention also relates to the mirror obtained by tempering a mirror to be tempered or a temperable mirror as described previously. Such a mirror particularly finds its use as an element of a kitchen backsplash panel.

Finally, the invention relates to a process for manufacturing a mirror to be tempered or a temperable mirror as described previously, characterized in that it comprises the steps of:

a. depositing onto a substrate, onto all or part of at least one of the faces of a glass substrate, a stack of thin layers comprising at least one chromium-based or niobium-based metal layer, one or more underlayers made of dielectric materials, and one or more overlayers made of dielectric materials, said layers of said stack being deposited via the techniques of vacuum cathodic sputtering, especially magnetron-assisted,

b. depositing a coating layer based on an aqueous solution of alkaline silicate and at least one pigment onto all or part of at least one of the faces of said substrate, over said stack,

c. drying said coating, in a single step, at a temperature below 400° C., preferentially below 300° C., and even more preferentially below 200° C.

Preferably, in such a process for manufacturing a tempered mirror, the mirror to be tempered or temperable mirror thus obtained is subjected to a heat treatment, in particular tempering, at a temperature above 600° C.

For the purposes of the present invention, the chromium-based or niobium-based metal layer is the layer for obtaining the mirror effect of the glazing, i.e. the layer reflecting a significant part of the visible light for the formation of the image. For the purposes of the present invention, the chromium-based or niobium-based layer deposited onto its glass substrate has a light reflection R_{L} of at least 50%, or even of at least 55%, within the meaning of standard ISO 9050:2003. In particular, the thickness of such layers is adjusted to give the glazing such a level of reflection.

The chromium-based or niobium-based metal layer normally very predominantly, or even exclusively, comprises said metal (with the exception of the inevitable impurities), even though an alloy with other metals, nevertheless in a minor amount, may be envisaged according to the invention. For example, in such a case, the content of the other metal(s) (other than chromium or niobium) present in the alloy is preferentially, in total, less than 20 atom %, usually less than 10 atom % or even less than 5 atom %.

The term “metal layer” means that the niobium-based or chromium-based layer does not comprise any carbon or any heteroatom such as nitrogen, oxygen or sulfur.

With the use of a coating as described previously, the tests performed by the Applicant Company made it possible to demonstrate very high adhesion of the coating described previously to the stack of layers, simply after application and drying of the coating, and also a mechanical strength sufficient to envisage the storage and transportation of non-tempered mirror glazings, the final heat treatment of which may thus be performed at the very place of transformation of the glazing, to the desired final shapes and sizes.

According to the invention, the coating layer deposited onto the glass substrate is an aqueous solution essentially comprising the alkaline silicate and the pigment, this solution being, according to an advantageous possibility, free of adhesion promoter. The layer of paint is in principle applied directly onto the substrate on its face equipped with the stack of thin layers.

The substrate equipped with the stack and thus coated with such a coating layer in particular has surprising chemical and mechanical strength characteristics, even without having undergone tempering. It is thus transportable and storable immediately after drying the coating layer, without an additional consolidating heat treatment, in particular tempering.

As indicated previously, it may thus be formed at a different place from its site of production, in particular cut, in a subsequent step, after its transportation and storage.

The coating layer according to the invention generally has, after drying typically at a temperature below 300° C., or even below 200° C., adhesion to the substrate of less than or equal to 2, or even less than or equal to 1, as measured by the grid test according to standard ISO 2409:2007.

For the purposes of the present invention, the mirror is “temperable” in the sense that said mirror can meet, after said tempering, the safety standard EN 12150-1:2000.

Preferably, after drying, the coating comprises between 5% and 30% by mass, preferentially between 5% and 20% by mass, of sodium silicate, potassium silicate and/or lithium silicate. Sodium or, most particularly, potassium silicates are preferred.

For the purposes of the present invention, the term “drying” means removal of the water present in the aqueous solution used to deposit the coating layer, in particular via a heat treatment at between 100 and 300° C.

According to the invention, the paint also comprises at least one white or, preferably, colored or even substantially black inorganic pigment. The pigment is preferably initially introduced, in powder form, into the aqueous preparation serving to deposit the coating layer. It is preferably black or substantially black, but may also have other shades, provided that it gives the final mirror (i.e. after tempering) the required opacity, in particular a light transmission of less than 0.5%, preferably less than 0.1%, within the meaning of international standard ISO 9050 (2003).

Examples of such pigments are, for example, oxides or sulfides comprising at least one element chosen from iron, manganese, copper, aluminum, chromium, antimony or cobalt, this list obviously not being in any way exhaustive.

A few examples of black pigments that may be used according to the invention are given below: pigments based on iron oxides, iron manganese oxide, iron titanium oxide, manganese oxide, chromium oxide, cobalt oxide, tin antimony oxide.

Preferably, the pigment used is an oxide comprising iron and/or manganese and/or chromium.

Very preferably, the pigment used is an iron oxide.

The pigments normally represent between 5 and 50% of the mass of the coating layer, after removal of the solvent (water) and preferably between 10 and 40%, or even between 20 and 30%, of the mass of the coating layer, after removal of the solvent.

The mineral paint may optionally comprise mineral fillers chosen from magnesium silicates such as talc, alumina, limestone, kaolin, clay and barium sulfate. The content of fillers in the composition of the coating layer may range up to 60% by mass.

The mineral paint may also comprise between 0 and 5% by mass, preferably less than 3% by mass, of a dispersant, an antifoam agent, a thickener, a stabilizer and/or a hardener. The dispersant, antifoam agent and thickener may especially be present in contents of less than 1% by mass.

The hardener may especially be an aluminum hydroxide or phosphate. Mention will be made, for example, of the Fabutit® products from the company Chemische Fabrik Budenheim KG.

As dispersant, mention may be made, for example, of the compound Tego 740® from the company Evonik.

As antifoam agent, mention may be made, for example, of the compound Foamex 825® from the company Evonik.

The thickener may be, for example, the compound Betolin V30® from the company Woellner.

As stabilizer, mention may be made, for example, of the compound Betolin Q40® from the company Woellner.

The mineral paint may comprise pigment particles with a mean size of less than 5 μm, preferably less than 2 μm, to further increase its opacity. The term “mean size” means the median diameter d₅₀ of said particles, measured especially according to the usual techniques of laser particle size analysis in accordance with standard ISO 13220.

The coating layer deposited on the substrate equipped with the stack has a thickness of at least 10 μm, and is generally between 20 and 100 micrometers. Typically, the layer has a thickness of between about 50 micrometers and about 80 micrometers.

Deposition of the coating layer may be performed via any technique known to those skilled in the art relating to liquid-route deposition. Mention will be made, for example, of deposition by sputtering, with a roller, with a curtain, by laminar coating, with a film spreader or by screen printing.

The drying step is preferentially performed at a temperature below 400° C. and even more preferentially below 300° C., or even below 200° C. The drying time is generally less than 15 minutes, preferentially less than 10 minutes. The temperature rise during the drying step is performed with a ramp of less than 100° C./minute and preferably between 70 and 90° C./minute.

The preparation used in the process according to the present invention is preferably an aqueous solution based on alkaline silicate and pigment(s). Said aqueous solution comprises, for example, between 3% and 30% by mass, preferentially between 5% and 15% by mass, of sodium silicate, potassium silicate and/or lithium silicate. Lithium or potassium silicates are particularly preferred. The preparation also comprises at least one inorganic pigment as described previously, for giving the coating layer the desired coloring and opacity to the mirror finally obtained.

The example below illustrates the advantages of the present invention without limiting its scope.

### EXAMPLE

According to the example according to the invention, a low light transmission glazing is manufactured according to the invention in accordance with the teaching of patent application EP962429. The layers of the stack are deposited via the standard magnetron techniques.

The glazing thus obtained may be described as follows:
Glass (Planiclear™)/15 nm SiNₓ/35 nm Cr/15 nm SiNₓ/4 nm Ti.

The glazing coated with the stack of layers does not undergo any heat treatment, especially tempering, after deposition of the stack of thin layers.

Onto the stack comprising the chromium-based metal layer is deposited an additional coating layer using an aqueous solution comprising a potassium silicate and pigments, with a dry extract of 58.5% by weight. The aqueous solution deposited onto the glazing is a black mineral paint sold by the company Unikalo under the reference “Kalium Silikat Finition Lisse Noire” comprising a black pigment based on iron oxide.

After drying, the paint has the following colorimetric characteristics: L*=25; a*=0.6, b*=0.6.

The dry extract has the following mass composition of oxide, as measured by XPS (X-ray photoelectron spectrometry):

| C | Fe₂O₃ | MnO | CaO | TiO₂ | K₂O | SiO₂ | Al₂O₃ | Mg0 | Na₂O |
|---|---|---|---|---|---|---|---|---|---|
| 15% | 31% | 0.6% | 28% | 0.3% | 6% | 15% | 1% | 3% | 0.5% |

The rheology of the paint is suitable for substantially uniform deposition onto the support with a slight dilution with a diluent product sold by the company Unikalo under the reference “Kalium Silikat Diluant Fixatif”. After dilution, the paint has a dry extract of about 50% by weight.

The aqueous composition is applied with a film spreader onto the precleaned glass substrate. The film is spread at a uniform speed, so that the wet thickness of the deposited film is about 150 micrometers. The coating layer is dried by a gradual rise up to 150° C. over a time of about 10 minutes.

The layer obtained has a final thickness of about 70 μm. After drying, it visually appears black and particularly hard and resistant, with strong adhesion to the substrate even in the absence of a consolidating heat treatment.

The following tests were performed to characterize the properties of the mirror for tempering thus obtained:

1°) Opacity test: the mirror is placed on a black support and then on a white support, the values L, a* and b*, according to the CIE L*a*b* international system, being measured through the mirror with a Minolta CM 2600d spectrometer for each support. The values ΔL*; Δa*; Δb* are obtained by subtracting the value of the measurement on the black background from the reference value on the white background.
For example: ΔL*=(L* on black background)−(L* on white background).
The opacity of the mirror is calibrated by calculating the difference between the two measurements according to the standard formula:

ΔE*=\sqrt{(L₁−L₂)²+(a₁−a₂)²+(b₁−b₂)²}

The opacity is judged to be satisfactory for a mirror if the ΔE value is less than 0.5%.
2°) Adhesion test of the coating: The test, often referred to as the cross cut test, consists in producing a standardized grid using a cutter on the lacquer face. Using a reference table, a rating is defined which makes it possible to quantify the adhesion and thus to be able to make comparisons between the samples. The lower the rating, the greater the adhesion. The test conducted is performed in accordance with standard ISO 2409:2007.
A maximum rating of 1 is expected to ensure any degradation of the mirror especially during its storage or transportation.
3°) Durability test under humid conditions. This test, often referred to as the high humidity test or HH test, is performed in accordance with the standard EN1036. It consists in placing the sample in an atmosphere containing 100% humidity for 7 or 21 days at 40° C. and then inspecting it visually to check the state of the coating. This test makes it possible to measure within a very short time the expected aging of the mirror under humid conditions, in particular in a kitchen or a bathroom. Absence of detachment of the coating is necessary to ensure any degradation of the mirror, during its use or even during its storage or transportation.
4°) Durability test at elevated temperature. This test, often referred to as the high temperature test, is performed in accordance with the standard EN1036. It consists in placing the sample in an atmosphere whose humidity is not controlled for 7 days at 65° C. and then inspecting it visually to check the state of the coating. This test makes it possible to measure within a very short time the expected aging of the mirror under hot conditions, in particular such as in a kitchen. Absence of detachment of the coating is necessary to ensure any degradation of the mirror, during its use or even during its storage or transportation in countries with very strong sunshine.

A sample of a mirror in accordance with the present example, i.e. obtained under the same conditions as described previously, undergoes tempering at 700° C., followed by rapid cooling to room temperature.

The same tests as indicated previously are once again conducted on the tempered mirror.

The results obtained are all collated in Table 1 below:

TABLE 1

| | | | | Durability |
|---|---|---|---|---|
| | | | Humidity | test at |
| | Opacity | Adhesion | durability | elevated |
| | test | test | test | temperature |
| Non-tempered | ΔE < 0.5 | N = 1 | No | No |
| mirror | | | detachment | detachment |
| Tempered | ΔE < 0.5 | N = 0 | No | No |
| mirror | | | detachment | detachment |

It is seen that the mirror before tempering, or even in the absence of any heating other than the drying of the coating layer, has adhesion and durability characteristics that are capable of preventing any problem during any storage or transportation, even in the absence of a consolidating heat treatment.

In addition, the results collated in the preceding table also show that the mirror after tempering has all the characteristics required for its use in humid and/or hot environments, such as on a backsplash panel of a kitchen or in a bathroom.

1. A mirror to be tempered or a temperable mirror, comprising:
a. a glass substrate,
b. a stack of thin layers deposited on one face of said substrate, said stack comprising a chromium-based or niobium-based metal layer, one or more underlayers made of dielectric materials, and one or more overlayers made of dielectric materials, said one or more underlayers and one or more overlayers being arranged, respectively, below and above the metal layer, with reference to the glass substrate,
c. a coating layer above said stack of thin layers with reference to the glass substrate,
in which said coating layer is a layer of mineral paint comprising a mixture of an alkaline silicate and at least one white, colored or black pigment.

2. The mirror as claimed in claim 1, in which the coating layer has an L* value of less than or equal to 50, in the CIE L*a*b* system.

3. The mirror as claimed in claim 1, in which the coating layer has an L* value of less than or equal to 30, in the CIE L*a*b* system.

4. The mirror as claimed in claim 1, in which the thickness of the chromium-based or niobium-based layer is between 10 and 100 nm.

5. The mirror as claimed in claim 1, in which the metal layer is based on chromium.

6. The mirror as claimed in claim 1, in which the metal layer is based on niobium.

7. The mirror as claimed in claim 1, in which the coating layer comprises between 5% and 15% by mass of sodium silicate, potassium silicate and/or lithium silicate.

8. The mirror as claimed in claim 1, in which the coating layer comprises between 5% and 50% by mass of pigment.

9. The mirror as claimed in claim 1, in which the coating layer comprises at least one pigment chosen from oxides or sulfides comprising at least one element chosen from iron, manganese, copper, aluminum, chromium, antimony or cobalt; titanium, silicon, copper, aluminum, chromium, cobalt, iron or manganese oxides or sulfides; zinc, cerium and/or cadmium sulfide; nickel and/or chromium titanates; or bismuth vanadate.

10. The mirror as claimed in claim 1, in which the coating layer comprises at least one pigment based on iron oxide, iron manganese oxide, iron titanium oxide, manganese oxide, chromium oxide, cobalt oxide, tin antimony oxide.

11. The mirror as claimed in claim 1, in which the coating layer also comprises a dispersant, an antifoam agent, a thickener, a stabilizer and/or a hardener.

12. The mirror as claimed in claim 11, in which said agents are present in an amount of between 0.01 and 5% by mass of the paint.

13. The mirror as claimed in claim 1, in which the coating layer comprises pigment particles less than 5 micrometers in size.

14. The mirror as claimed in claim 1, in which the coating layer has a thickness of at least 10 micrometers.

15. A mirror obtained by tempering a mirror to be tempered as claimed in claim 1.

16. A process for manufacturing a mirror to be tempered or a temperable mirror as claimed in claim 1, comprising:
a. depositing onto a substrate, onto all or part of at least one face of a glass substrate, a stack of thin layers comprising at least one chromium-based or niobium-based metal layer, one or more underlayers made of dielectric materials, and one or more overlayers made of dielectric materials, said one or more layers of said stack being deposited via the techniques of vacuum cathodic sputtering,
b. depositing a coating layer based on an aqueous solution of alkaline silicate and at least one pigment onto all or part of at least one of the faces of said substrate, over said stack,
c. drying said coating, in a single step, at a temperature below 400° C.

17. A process for manufacturing a tempered mirror as claimed in claim 16, in which the mirror to be tempered or temperable is subjected to a heat treatment at a temperature above 600° C.

18. A method comprising manufacturing a kitchen backsplash panel with a tempered mirror as claimed in claim 17.

19. The mirror as claimed in claim 4, in which the thickness of the chromium-based or niobium-based layer is between 20 and 80 nm.

20. The mirror as claimed in claim 19, in which the thickness of the chromium-based or niobium-based layer is between 30 and 70 nm.

21. The mirror as claimed in claim 8, in which the coating layer comprises between 10% and 30% by mass of pigment.

22. The mirror as claimed in claim 12, in which said agents are present in an amount of between 0.01 and 1% by mass of the paint.

23. The mirror as claimed in claim 13, in which the coating layer comprises pigment particles less than 2 micrometers in size.

24. The mirror as claimed in claim 14, in which the coating layer has a thickness of at least 20 micrometers.

25. The mirror as claimed in claim 24, in which the coating layer has a thickness of at least 50 micrometers.

26. The process as claimed in claim 16, in which the temperature is below 300° C.

27. The process as claimed in claim 16, in which the vacuum cathodic sputtering is magnetron-assisted.

28. The process as claimed in claim 17, in which the heat treatment is a tempering treatment.
